(19) United States
(12) Patent Application Publication
(10) Pub. No.: US 2026/0335819 A1
(43) Pub. Date: Oct. 29, 2026

(54) Atomizing Corona Purification Device For Oil Smoke Exhaust Gas and Purification Method Thereof

(71) Applicant: SUZHOU UNIVERSITY OF SCIENCE AND TECHNOLOGY, Jiangsu (CN)

(72) Inventors: Xing ZHANG, Jiangsu (CN); Yubin CHI, Jiangsu (CN); Haibo YU, Jiangsu (CN); Jinxin WU, Jiangsu (CN); Yuan PENG, Jiangsu (CN); Jisuo ZHANG, Jiangsu (CN); Hailong LI, Jiangsu (CN); Bo YIN, Jiangsu (CN); Jie DAI, Jiangsu (CN)

(21) Appl. No.: 19/109,040

(22) PCT Filed: Sep. 4, 2023
(86) PCT No.: PCT/CN2023/116668

§ 371 Date: Mar. 5, 2025

(30) Foreign Application Priority Data
Sep. 5, 2022 (CN) CN202211076777.7

(51) Int. Cl. B01D 53/32; B03C 3/01; B03C 3/10; B03C 3/41; B03C 3/47; B03C 3/82

(52) U.S. Cl. CPC B01D 53/32; B03C 3/01; B03C 3/10; B03C 3/41; B03C 3/47; B03C 3/82; B01D 2258/02; B01D 2259/818

(57) ABSTRACT

This electrostatic precipitator includes: metal dust-collecting electrode plates (2) that trap dust in a dust-containing airflow; a rotating shaft (13) that receives a rotational force from a drive motor and rotates the dust-collecting electrode plates (2); metal charge electrode plates (9) that are disposed so as to face the dust-collecting electrodes plates (2) with a predetermined interval therebetween; and discharge pins (14a) that are respectively disposed on the charge electrode plates (9) on the upstream side of the dust-containing airflow. A surface of each dust-collecting electrode plate (2) is provided with an oleophobic anti-fouling layer (40a). Dust that has been electrically charged by the discharge of the discharge pins (14a) and adhered to the anti-fouling layers (40a) is removed by a centrifugal force generated by the rotation of the dust-collecting electrode plates (2).

### CROSS REFERENCE TO RELATED APPLICATIONS

This application is a national phase entry under 35 U.S.C. § 371 of International Application No. PCT/CN2023/116668, filed on Sep. 4, 2023, which claims priority to Chinese Patent Application No. 202211076777.7, filed on Sep. 5, 2022, the entire contents of all of which are incorporated herein by reference.

### TECHNICAL FIELD

Embodiments of the present invention relate to the field of air pollution control, and in particular to an atomizing corona purification device for oil smoke exhaust gas and a purification method thereof.

### BACKGROUD TECHNOLOGY

Oil fumes produced by industry or restaurants have seriously jeopardized the environment and human safety. Although there are existing purification devices that use electrocoagulation components, the electrocoagulation components are set up in the form of multiple discharge electrodes, which do not evenly distribute the exhaust gas after it enters, and the treatment effect is not satisfactory.

In addition, in the technology of corona discharge treatment of exhaust gas using corona discharge parts, the corona discharge parts cannot rotate, and soot particulates are easily deposited onto the corona discharge parts, resulting in poor treatment efficiency and even the need periodic cleaning of the corona discharge parts.

Considering that multiple parts in the exhaust treatment need to be cleaned, it is desirable to clean as few parts as possible.

### SUMMARY

The purpose of the present invention is to provide an atomizing corona purification device for oil smoke exhaust gas and a purification method thereof which is capable of efficiently purifying the oil smoke exhaust gas. The technical solution of the present application organically combines the advantages of the electrocoagulation component as an electrocoagulation treatment module, the advantages of the atomizing nozzle and the dynamic twisted cage corona discharge component working together to produce an atomizing corona treatment effect and self-cleaning effect, and the dynamic adsorption plate rotating to realize the self-cleaning effect. In this way, the purification device for oil smoke exhaust gas and the purification method of the present application not only can always maintain a very high treatment effect, but also can realize the function of self-cleaning, avoiding the effect of frequent cleaning of internal parts.

According to an aspect of the present invention, there is provided an atomizing corona purification device for oil smoke exhaust gas, wherein the atomizing corona purification device for oil smoke exhaust gas is individually provided with an air inlet and an air outlet at each end of a housing thereof, and within the housing is provided with:
an electrocoagulation component, configured to cause charge coagulation and agglomeration of soot particulates in the oil smoke exhaust gas;
an atomizing corona rotating component, which includes a water pass-through shaft, atomizing nozzles disposed at intervals on the water pass-through shaft, and a plurality of discharge electrodes arranged in the shape of a twisted cage on a surface of the water pass-through shaft, by rotating the plurality of discharge electrodes the soot particulates which were treated by atomizing corona are flinging onto an inner wall of the housing; and
a dynamic adsorption plate, the dynamic adsorption plate comprising rotating adsorption electrode plates, the adsorption electrode plates flinging at least a portion of the remaining soot particulates onto the inner wall of the housing.

According to another aspect of the present invention, there is provided a purification method using the above-described atomizing corona purification device for oil smoke exhaust gas, comprising the following steps:
entering the housing through the air inlet for the oil smoke exhaust gas to be purified;
electrically charging and agglomerating the soot particulates in the oil smoke exhaust gas by using electrocoagulation component;
by rotating the atomizing corona rotating component, inhaling the oil smoke exhaust gas which has been treated by the electrocoagulation components, forming a first vortex rotating counterclockwise or clockwise, flinging the oil smoke particulates in the first vortex to the inner wall of the the housing after being processed by the atomizing corona of the atomizing nozzles and the discharge electrodes;
forming a second vortex in the opposite direction to the first vortex by rotating the adsorption electrode plates in the dynamic adsorption plate, and flinging at least a portion of the remaining soot particulates onto the inner wall of the housing after being adsorbed by the adsorption electrode plates.

The first form of the electrocoagulation component can be set as follows:
the electrocoagulation component comprises an airflow perforation plate and a plurality of omnidirectional drawing wire conductors arranged on the airflow perforation plate, wherein the airflow perforation plate is provided with a plurality of airflow perforations, and the omnidirectional drawing wire conductors are provided between adjacent airflow perforations.

The airflow perforations are arranged in a plurality of rows on the airflow perforation plate and the airflow perforations are spaced apart in each row of airflow perforations.

One omnidirectional drawing wire conductor is provided at a central region of four airflow perforations between two adjacent rows of airflow perforations, and the plurality of omnidirectional drawing wire conductors are connected to each other by conductive wires.

The airflow perforation is in the shape of a circle, oval or rectangle and the omnidirectional drawing wire conductor is in the shape of a four-pointed star.

Two adjacent rows of omnidirectional drawing wire conductors are connected to a high voltage electrode and a grounding electrode of the AC high voltage power supply; the omnidirectional drawing wire conductors made of tungsten wire, steel wire, or corona spur wire, are shaped as serrated, needle-pointed, spiked, thistle-like wire or wire mesh.

The second form of the electrocoagulation component can be set up as follows:
the electrocoagulation component comprises an airflow perforation plate and a plurality of omnidirectional drawing wire conductors arranged on the airflow perforation plate, wherein the airflow perforation plate is provided with a plurality of airflow perforations, and each airflow perforation is provided with an omnidirectional drawing wire conductor.

The airflow perforations are arranged in a plurality of rows of airflow perforations on the airflow perforation plate and the airflow perforations are spaced apart in each row of airflow perforations.

One omnidirectional drawing wire conductor is provided at the central region of each airflow perforation, and the plurality of omnidirectional drawing wire conductors are connected to each other by conductive wires.

The airflow perforation is in the form of a circle, oval or rectangle, and the omnidirectional drawing wire conductors are in the form of center radiation.

Two adjacent rows of omnidirectional drawing wire conductors are connected to a high voltage electrode and a grounding electrode of the AC high voltage power supply.

The omnidirectional drawing wire conductor made of tungsten wire, steel wire or corona spur wire, is in the shape of serrated, pinpoint, spiked, thistle-like wire or wire mesh.

The third form of the electrocoagulation component can be set as follows:
the electrocoagulation component comprises an airflow perforation plate and a plurality of omnidirectional drawing wire conductors arranged on the airflow perforation plate, wherein the airflow perforation plate is provided with a plurality of airflow perforations, the airflow perforations are provided with the omnidirectional drawing wire conductors, and the omnidirectional drawing wire conductors are provided with ventilation holes.

The airflow perforation is arranged in a plurality of rows of airflow perforation on the airflow perforation plate, and the airflow perforations are spaced apart in each row of airflow perforations.

One omnidirectional drawing wire conductor is provided at a central region of each airflow perforation, one ventilation hole is provided in each omnidirectional drawing wire conductor, and the plurality of omnidirectional drawing wire conductors are connected to each other by conductive wires.

The airflow perforation is in the form of a circle, oval or rectangle, the omnidirectional drawing wire conductor is in the form of a circle with a plurality of evenly spaced discharge wires, and the ventilation holes are circular.

Adjacent omnidirectional drawing wire conductors are separately connected to a high voltage electrode and a grounding electrode of an AC high voltage power supply.

Discharge wires made of tungsten wire, steel wire or corona spur wire are in the shape of serrated, needle-pointed, spiked, thistle-like wire or wire mesh.

The fourth form of the electrocoagulation component can be set as follows:
the electrocoagulation component comprises an airflow perforation plate and a plurality of discharge flower-shaped conductors in the form of a Bauer ring structure arranged on the airflow perforation plate, wherein the airflow perforation plate is provided with a plurality of airflow perforations, and the airflow perforations are provided with the discharge flower-shaped conductors.

The airflow perforations are arranged in a plurality of rows of airflow perforations on the airflow perforation plate and the airflow perforation are spaced apart in each row of airflow perforations;

One discharge flower-shaped conductor is provided at a central region of each airflow perforation, each discharge flower-shaped conductor comprising a plurality of ligulate conductors staggered at intervals along a wall of the space forming the airflow perforations, the plurality of ligulate conductors being connected to each other by conductive wires.

An other region of the central region within the airflow perforation than the plurality of ligulate conductors are formed with an ventilation hole to allow passage of oil smoke exhaust gas.

The airflow perforation is circular, oval or rectangular, the plurality of the ligulate conductors within each airflow perforation take the form of a circle formed petal-like, and the ventilation holes are circular;

Adjacent discharge flower-shaped conductors are connected to a high voltage electrode and a grounding electrode of an AC high voltage power supply respectively.

The ligulate conductors made of tungsten wire, steel wire or corona spur wire are in the shape of serrated, pinpointed, spiked, thistle-like wire or wire mesh.

By use of electrocoagulation components, the electrocoagulation components provided with a number of airflow perforations can play a well-distributed role in the airflow, and when passing the airflow, due to the AC high-voltage power supply provides power to the omnidirectional drawing wire conductors and the adjacent two rows of omnidirectional drawing wire conductors are respectively connected to the high-voltage electrode and the grounding electrode of the high voltage AC power supply, so that the gas in the vicinity of the omnidirectional drawing wire conductor is ionized and produces a large number of charges, the small-sized soot particulates in the oil smoke exhaust gas are condensed and agglomerated under the action of alternating electric field to form large-sized soot particulates, and then are charged.

Additionally, the omnidirectional drawing wire conductors are arranged in such a way that both the inner and outer rings thereof can pass through the exhaust gas flow, which can double the treatment effect and improve the treatment efficiency.

In addition, the dynamic twisted cage corona discharge component is used to provide centrifugal force and electric field force, when the soot particulates pass through the dynamic twisted cage (horizontal) corona discharge component, the gas (exhaust gas) near the discharge electrodes is ionized by discharge electrodes which are powered by the negative high-voltage DC power supply, generates a large number of negative charges, and large-sized soot particulates in the oil smoke exhaust gas are negatively charged under the effect of the negative DC corona; at the same time, since the discharge electrodes in the dynamic twisted cage (horizontal) corona discharge component are rotating at a high speed, it can generate centrifugal force, and the large-sized soot particulates in the oil smoke exhaust gas are thrown to the surface of the cylinder wall of the corona discharge component under the effect of centrifugal force, and then collected in the oil collecting groove and discharged through the oil discharge valve.

In this way, it not only improves the airflow distribution, but also makes it possible to achieve a self-cleaning effect by not depositing soot particulates on the dynamic twisted cage corona discharge components, which improves the treatment effect and eliminates the need for regular cleaning.

An atomizing nozzle assembly in combination with dynamic twisted cage corona discharge component realizes the atomizing corona. The atomizing corona plasma technology takes into account the advantages of both electrostatic deposition and plasma technology, which can realize the synergistic control of a variety of pollutants in the oil smoke exhaust gas.

The discharge electrode produces negative corona discharge under the action of negative high voltage DC power supply. In the corona discharge process, the atomizing water supply system continuously supplies water to the discharge electrodes, making the discharge electrode surface to form electrohydrodynamic atomizing film, while the atomized water droplets are highly charged by free electrons and ions, under the action of the electric field, high-speed flying to the housing wall to achieve the purification of soot particulates. Besides wet electrostatic dust removal mechanism, atomizing corona plasma technology is added with atomizing corona discharge which increases the power coagulation of high-speed water droplets, electrostatic coagulation of charged water droplets, as well as electronic charging of micro/small dust and other purification mechanisms, and therefore has a higher removal efficiency of small dust.

As the water being continuously supplied to the discharge electrode, it can be continuously atomized to prevent oil droplets from sticking to the discharge electrodes and dust collection electrodes, ensuring the device has long-term stable and efficient operation, the atomizing corona plasma removes VOCs from the oil smoke exhaust gas and eliminates the odor. In addition, atomizing corona plasma can purify the circulating water at any time, minimizing the volume of emitted pollution water to a large extent.

In the corona discharge process, the air is brokendown instantly to generate plasma, plasma contains free electrons, high-energy particles and active particles, in which the water mist can further react with the plasma to generate·OH, ·O and other highly active radicals, O₃ and other strong oxidizing molecules; These highly active radicals·OH, ·O and strong oxidizing molecules O₃ can be reacted with VOCs and gas phase molecules with bad odors and smells in the oil smoke exhaust gas to generate non-toxic and harmless small molecules, such as CO₂, H₂O and other small molecules.

By rotating the adsorption electrode plate, the dynamic adsorption plate can not only increase the area of contact with oil smoke exhaust gas, improve the treatment effect, but also shake off the soot deposits to realize the self-cleaning function, especially, the treatment effect can be significantly improved, when the direction of rotation of the adsorption electrode plate is synergistical with the direction of the discharge electrodes.

From the descriptions of the embodiments of the present disclosure with reference to the drawings below, other objectives and advantages of the present disclosure will become apparent, and will aid in a comprehensive understanding of the present disclosure.

### BRIEF DESCRIPTION OF THE DRAWINGS

The invention will be described in further detail with reference to the accompanying drawings, in which:

FIG. 1A is a schematic cross-sectional view of an atomizing corona purification device for oil smoke exhaust gas provided by an embodiment of the present invention;

FIG. 1B is a schematic cross-sectional view of an alternative example of FIG. 1A;

FIG. 1C is a schematic cross-sectional view of another alternative example of FIG. 1A;

FIG. 2A is a schematic diagram of an electrocoagulation component in an atomizing corona purification device for oil smoke exhaust gas in accordance with an embodiment of the present invention;

FIG. 2B is a schematic diagram of an alternative example of FIG. 2A;

FIG. 2C is a schematic diagram of another example of FIG. 2A;

FIG. 2D is a schematic diagram of yet another example of FIG. 2A;

FIG. 3A is a schematic diagram of an atomizing corona rotating component in the atomizing corona purification device for oil smoke exhaust gas described in the present invention;

FIG. 3B is an overall schematic view of a twisted cage corona discharge part of FIG. 3A;

FIG. 3C is a schematic diagram of an atomizing corona rotating component with an atomizing nozzle as described in the present invention;

FIG. 3D is a schematic cross-sectional view of the atomizing corona rotating component of FIG. 3C;

FIG. 4A is a schematic diagram of a dynamic adsorption plate in the atomizing corona oil smoke exhaust gas purification device described in the present invention;

FIG. 4B is a schematic diagram of another variant example of the dynamic adsorption plate described in the present invention.

### DETAILED DESCRIPTION OF EXEMPLARY EMBODIMENTS

The technical solution of the present disclosure will be further specifically explained below by embodiments and in conjunction with the accompanying drawings. In the specification, the same or similar reference numbers indicate the same or similar components. The description of the embodiments of the present disclosure with reference to the drawings intends to explain the general inventive concept of the present disclosure and should not be understood as a limitation to the present disclosure.

Further, in the following detailed description, numerous specific details are set forth for ease of explanation to provide a full understanding of the embodiments of the present disclosure. It is apparent, however, that one or more embodiments can be implemented without these specific details.

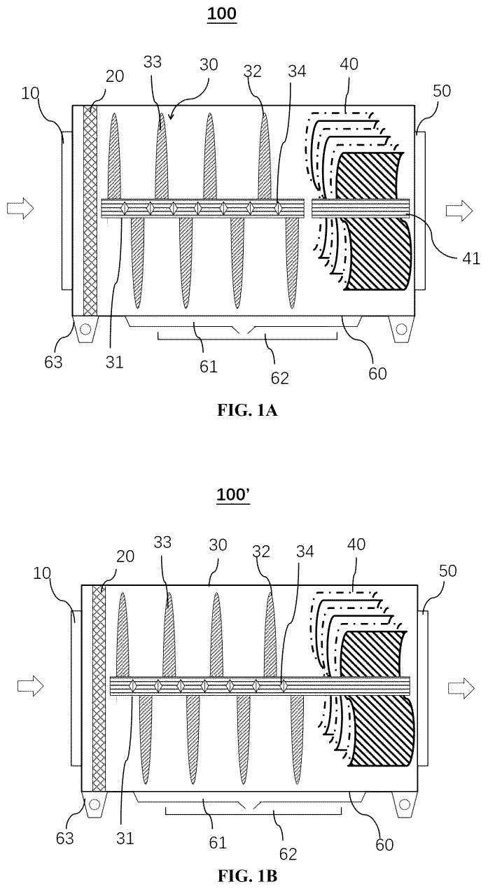

Referring to FIG. 1A, the atomizing corona purification device for oil smoke exhaust gas 100 is substantially cylindrical in shape. An air inlet 10 and an air outlet 50 are respectively provided at each end of the cylindrical housing 60. Both the air inlet 10 and the air outlet 50 are provided as annular steps with diameters smaller than the diameter of the housing 60.

Specifically, the meaning of dynamic in the names of the respective components of the atomizing corona purification device for oil smoke exhaust gas 100 is that the components therein for treating the exhaust gases are rotatable, and compared with the static situation in the prior art, that is, in the sense of being able to rotate or swivel.

An electrocoagulation component 20, an atomizing corona rotating component 30, a dynamic adsorption plate 40 and other components are provided in the housing 60. As mentioned before, in the present application, in order to realize the convenience of collecting the treated soot particulates, a long strip oil collection groove 61 is provided at the bottom of the housing 60, and the atomizing corona rotating component 30, and the dynamic adsorption plate 40 throws the collected soot particulates onto the inner wall of the housing 60 in the process of rotation. By setting them uniformly in one housing, one oil collecting groove 61 can be shared herein for simplifying the structure. An oil collection box 62 can be provided on the underside of the oil collection groove 61, and the oil collection groove 61 and the oil collection box 62 can be connected through an opening of the oil collection groove 61, so that the oil collection box 62 can be removed to discharge the soot particulates in the oil collection box 62. In one example, support legs 63 may also be provided at the bottom or four corners of the housing 60.

The oil smoke exhaust gas to be purified first enters through the air inlet 10, and then passes through the electrocoagulation component 20, the atomizing corona rotating component 30, the dynamic adsorption plate 40 and finally flows out of the air outlet 50.

The electrocoagulation component 20 is configured to cause charge coagulation and agglomeration of soot particulates in the oil smoke exhaust gas. the atomizing corona rotating component 30 comprises a water pass-through shaft 31, atomizing nozzles 34 disposed at intervals on the water pass-through shaft 31 and a plurality of discharge electrodes 33 arranged in the shape of a twisted cage on the surface of the water pass-through shaft 31, the plurality of discharge electrodes 33 flinging the soot particulates which have been treated by the atomizing corona treatment onto the inner wall of the housing 60 by rotation.

the dynamic adsorption plate 40 comprises a rotating shaft 41 and an adsorption electrode plate 42 arranged thereon capable of rotating, the adsorption electrode plate 42 flinging at least a portion of the remaining soot particulate matter onto the inner wall of the housing 60.

In one embodiment, the electrocoagulation component 20 matches or conforms to the interior shape of the housing 60. That is, the periphery of the electrocoagulation component 20 is sealingly connected to the housing 60, preventing the oil smoke exhaust gas from passing through the periphery of the electrocoagulation component 20, resulting in a portion of the oil smoke exhaust gas not being electrocoagulation-processed.

The water-through shaft 31 of the atomizing corona rotating component 30 and the rotation shaft 41 of the dynamic adsorption plate 40 are set up as separate parts, which may allow the direction of rotation to be adjusted as desired. For example, the water-through shaft 31 is rotated by clockwise rotation to form a clockwise first vortex, while the rotation shaft 41 may be set to rotate counterclockwise to form a counterclockwise second vortex, and by setting the first vortex and the second vortex to be inverted, a greater airflow disturbance may be generated within the housing 60 to allow more oil smoke exhaust gas to pass through the adsorption electrode plate 42 of the dynamic adsorption plate 40, generating a more highly efficient electrostatic adsorption effect, and the purification efficiency is improved.

Referring to FIG. 1B, in the atomizing corona purification device for oil smoke exhaust gas 100′, the water-through shaft 31 of the atomizing corona rotating component 30 may be set up so that it has the same shaft as the rotation shaft of the dynamic adsorption plate 40. In this way, a vortex airflow in a uniform direction will be formed inside the housing 60, and by adjusting the rotational speed it can cause more oil smoke exhaust gas to collide with the inner wall of the housing 60 and fling more oil smoke particulates onto the inner wall of the housing 60, which is more conducive to the collection of the soot particulates, and provides a better self-Cleaning effect.

Referring to FIG. 1C, in the atomizing corona purification device for oil smoke exhaust gas 100″, the electrocoagulation component 20′ may also be provided to form a gap with the inner wall of the housing 60, thereby allowing the electrocoagulation component 20′ to be driven by its own rotating shaft or to be integrated on the water-through shaft 31 to simultaneously rotate with the atomizing corona rotating component 30 as it rotates. The structure can be further simplified by integrating the electrocoagulation component 20′ on one end of the water-through shaft 31, which is driven to rotate.

Similarly as discussed with respect to FIG. 1B, the electrocoagulation component 20′ may be provided to be capable of rotating, so that the electrocoagulation component 20′, the atomizing corona rotating component 30, and the dynamic adsorption plate 40 may all be provided to rotate on the same water-through shaft 31, which simplifies the structure and is more conducive to the generation of a stronger vortex of airflow, and greater flow of oil smoke exhaust gas through the purification device, and more soot particulates will be flung onto the inner wall of the housing 60. A better advantage is that the whole device no longer needs to be cleaned, and can all be self-cleaning.

In some embodiments, the electrocoagulation component 20 is set up as components of omnidirectional drawing wire conductor for electrocoagulation and treatment.

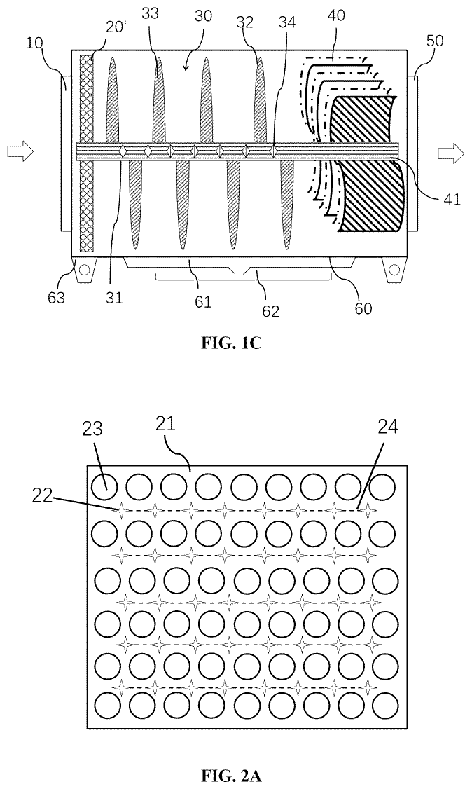

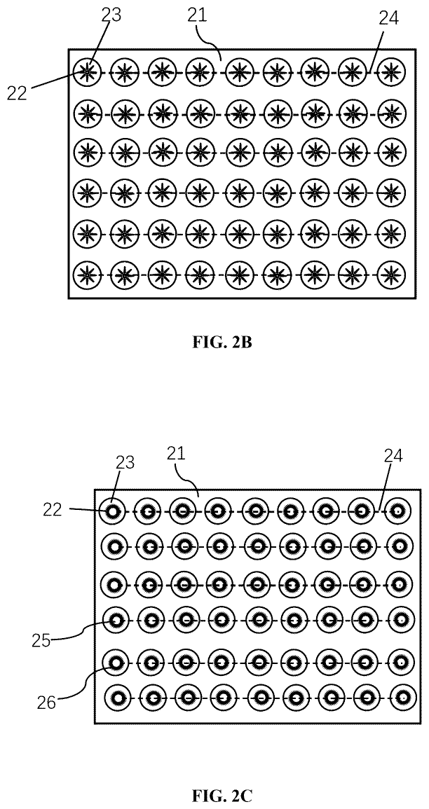

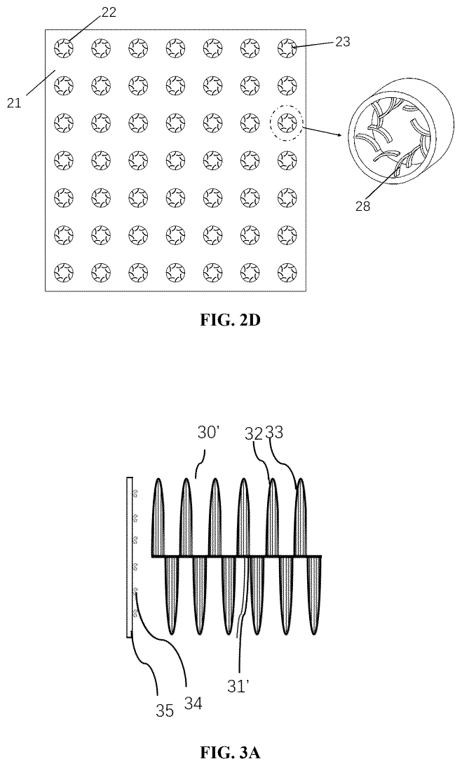

Referring to FIG. 2A, the electrocoagulation component 20 comprises an airflow perforation plate 21 and a plurality of omnidirectional drawing wire conductors 22 arranged on the airflow perforation plate 21, wherein the airflow perforation plate 21 is provided with a plurality of airflow perforations 23, and the omnidirectional drawing wire conductors 22 are provided between adjacent airflow perforations 23.

the airflow perforations 23 are arranged on the airflow perforation plate 21 in a plurality of rows of airflow perforations 23 and the airflow perforations 23 are spaced apart in each row of airflow perforations 23.

An omnidirectional drawing wire conductors 22 are provided at the central region of close four airflow perforations 23 between two adjacent rows of airflow perforations 23, and the plurality of omnidirectional drawing wire conductor 22 are connected to each other by a conductive wire 24.

The omnidirectional drawing wire conductor 22 made of tungsten wires, steel wires or corona spur wires are in the shape of serrated, needle-pointed, spiked, thistle-like wire or wire mesh. the airflow perforations 23 are in the form of a circle, oval or rectangle, the omnidirectional drawing wire conductor 22 is in the form of a four-pointed star, and two adjacent rows of omnidirectional drawing wire conductors 22 are connected to the high voltage electrode and a grounding electrode of an AC (alternating current) high voltage power supply, respectively.

Since the waveform of the AC high voltage power supply is positively and negatively staggered, the electric coagulation component 20 produces regular alternating changes in the electric field. When the charged soot particulates pass by, due to the alternating effect of the changing electric field, the positive and negative charged particles will move, thus colliding and condensing, and the small particles will condense and merge into large particles.

Referring to FIG. 2B, the electrocoagulation component 20 comprises an airflow perforation plate 21 and a plurality of omnidirectional drawing wire conductors 22 arranged on the airflow perforation plate 21, wherein the airflow perforation plate 21 is provided with a plurality of airflow perforations 23, and the airflow perforations 23 are provided therein with the omnidirectional drawing wire conductor 22.

the airflow perforations 23 are arranged on the airflow perforation plate 21 in a plurality of rows of airflow perforations 23 and the airflow perforations 23 in each row of airflow perforations 23 are spaced apart. One omnidirectional drawing wire conductor 22 is provided on the central region of each airflow perforation 23, and the plurality of omnidirectional drawing wire conductors 22 are connected to each other by conductive wires 24.

The omnidirectional drawing wire conductor 22 made of tungsten wire, steel wire or corona spur wire is shaped as a serrated, needle-pointed, spiked, thistle-like wire or wire mesh. the airflow perforation 23 is in the form of a circle, an oval or a rectangle, and the omnidirectional drawing wire conductors 22 are preferably arranged in the form of a double cross shape or radiating outwards from the center. Setting into this form allows the discharge area of the omnidirectional drawing wire conductor 22 to better contact the oil smoke exhaust airflow, thus achieving better treatment results. Setting up in a substantially double cross shape can function to evenly distribute the airflow, resulting in a more even distribution of the airflow.

The two adjacent rows of omnidirectional drawing wire conductors 22 are respectively connected to the high voltage electrode and the grounding electrode of the AC high voltage power supply. Alternatively, two adjacent omnidirectional drawing wire conductors 22 may be arranged to be connected to the high voltage electrode and the grounding electrode of the power supply, respectively.

Since the waveform of the AC high voltage power supply is positively and negatively staggered, the electrocoagulation component 20 produces regular alternating changes in the electric field. When the charged soot particulates pass by, due to the alternating effect of the changing electric field, the positive and negative charged particles will move, thus colliding and condensing, and the small particles will condense and merge into large particles.

Referring to FIG. 2C, the electrocoagulation component 20 comprises an airflow perforation plate 21 and a plurality of omnidirectional drawing wire conductors 22 arranged in the airflow perforation plate 21, wherein the airflow perforation plate 21 is provided with a plurality of airflow perforations 23, wherein the airflow perforations 23 are provided with the omnidirectional drawing wire conductors 22 therein, wherein the omnidirectional drawing wire conductors 22 are provided with ventilation holes 25.

The airflow perforations 23 are arranged on the airflow perforation plate 21 in a plurality of rows of airflow perforations 23 and the airflow perforations 23 are spaced apart in each row of the airflow perforations.

One omnidirectional drawing wire conductor 22 is provided at the central region of each airflow perforation 23, one ventilation hole 25 is provided in each omnidirectional drawing wire conductor 22, and the plurality of omnidirectional drawing wire conductors 22 are connected to each other by an electrically conductive wire 24.

The airflow perforation 23 is circular, elliptical or rectangular, the omnidirectional drawing wire conductor 22 is arranged in the form of a circle with a plurality of evenly spaced discharge filaments 26, and the ventilation holes 25 are circular; adjacent omnidirectional drawing wire conductors 22 are connected to a high voltage electrode and a grounding electrode of an alternating current high-voltage power supply, respectively.

The discharge wire 26 made of tungsten wire, steel wire or corona spur wire is shaped as a serrated, needle-pointed, spiked, thistle-like wire or wire mesh.

Since the AC high-voltage power supply waveform is positively and negatively interlaced, the electrocoagulation component 20 produces regular alternating changes in the electric field. When the charged soot particulates pass through the periphery of the omnidirectional drawing wire conductor 22 and through its corresponding ventilation hole 25, the positive and negative charged particles will move due to the alternating effect of the changing electric field, so that it can have the effect of double discharge treatment, so that the collision and coagulation can be better carried out, and the small particles will be coagulated and merged into the large particles, which improves the treatment effect.

Referring to FIG. 2D, the electrocoagulation component 20 comprises an airflow perforation plate 21 and a plurality of discharge flower-shaped conductors 22 in the form of a Bauer ring structure arranged on the airflow perforation plate 21, wherein the airflow perforation plate 21 is provided with a plurality of airflow perforations 23, and the airflow perforations 23 are provided with the discharge flower-shaped conductors 22 therein.

The airflow perforations 23 are arranged in a plurality of rows of airflow perforation on the airflow perforation plate 21 and the airflow perforations are spaced apart in each row of airflow perforations 23.

One discharge flower-shaped conductor 22 is provided at the central region of each airflow perforation 23, each discharge flower-shaped conductor 22 includes a plurality of ligulate conductors 28 staggered at intervals along the wall of the space forming the airflow perforation, the plurality of ligulate conductors 28 are connected to each other by conductive wires.

The central region within the airflow perforation 23 in addition to the plurality of ligulate conductors 28 is formed with ventilation holes allowing passage of oil smoke exhaust gas.

The airflow perforation 23 is circular, oval or rectangular, the plurality of the ligulate conductors 28 within each airflow perforation 23 takes the form of a circle formed by petals, and the ventilation holes are circular.

Adjacent discharge flower-shaped conductors 22 are connected to the high voltage electrode and the grounding electrode of the AC high voltage power supply, respectively.

The ligulate conductors 28 made of tungsten wire, steel wire or corona spur wire are shaped as a serrated, pinpointed, spiked, thistle-like wire or wire mesh.

By setting the discharge flower-shaped conductor 22 in the form of the Bauer ring structure, it can have the advantages of low resistance, high gas flux, high elasticity of the ligulate conductors 28, and high internal specific surface area leading to a higher discharge effect.

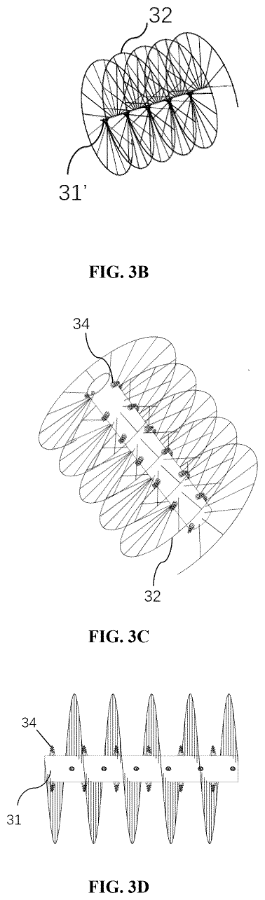

Referring to FIG. 3A, the atomizing corona rotating component 30′ may be provided in the form of further comprising an atomizing nozzle assembly in front of the twisted-cage corona discharge component, the atomizing nozzle assembly includes a plurality of nozzles 34 and a support plate 35, the plurality of nozzles 34 are uniformly disposed on the support plate 35 and connected by a pipe to the outside atomizing water supply system such that a liquid, such as water, may be ejected from the nozzles 34.

The atomizing nozzle assembly is arranged between the electrocoagulation component 20 and the atomizing corona rotating component 30′ and the nozzle 71 ejects liquid towards the atomizing corona rotating component 30′.

In one example, the plurality of atomizing nozzles 34 are hollow conical nozzles, and the spraying area of the plurality of atomizing nozzles 34 is circular. In this way, on the one hand, the heat in the oil smoke exhaust gas can be quickly transferred to achieve a cooling effect; on the other hand, a good airborne droplet impact effect can be achieved to form oil-in-water droplets, which can be captured in the back-end electrostatic adsorption region (dynamic adsorption plate 40) due to the charging of the oil-in-water droplets.

By combining the atomizing nozzle assembly and the atomizing corona rotating component 30′, it can be realized that the atomizing corona generates plasma, and the plasma system contains free electrons and active groups, which can effectively remove VOCs and malodorous gas pollutants.

The particulate size of the atomized droplets sprayed by the atomizing nozzle is between 2-50 μm, so that the sprayed atomized droplets are fine and uniform to achieve better results.

The spray angle of the atomizing nozzle 34 is at an angle of 25-150° with respect to the centerline of the housing 60. It is understood that the spray angle, the spray pressure, and the flow are adjusted according to the air volume of the treated oil smoke exhaust gas, with the spray angle being between 25-150° so that the goal of the best humidification and atomizing effect can be achieved.

It should be noted that the atomizing nozzle assembly in combination with the dynamic twisted cage (horizontal) discharge corona component is to achieve the role of atomizing corona. The atomizing corona plasma technology, taking into account the advantages of both electrostatic deposition and plasma technology, can synergistic control a variety of pollutants of the oil smoke exhaust gas.

The dynamic twisted cage (horizontal) discharge corona component includes a discharge electrode 33. The discharge electrode 33 generates a negative corona discharge under the action of a negative high-voltage direct current power supply. In the corona discharge process, the atomizing water supply system continuously supplies water to the discharge electrode 33 through the atomizing nozzle 34, causing the discharge electrode 33 to form an electrohydrodynamic atomized film on the surface of the discharge electrode 33, and at the same time, the atomized water droplets are highly charged by free electrons and ions, and under the action of the electric field, they fly at high speed to the housing 60 to realize the purification of the oil smoke exhaust gas and soot particulates. Atomizing corona plasma technology in addition to wet electrostatic dust removal mechanism, atomizing corona discharge to increase the power coagulation of high-speed water droplets, electrostatic coagulation of charged water droplets, as well as electronic charging of mirco-sized/small dust and other purification mechanisms, and thus has a higher removal efficiency of the small dust.

Since the discharge electrode 33 can be continuously atomized by suppling water, to avoid oil droplets from sticking to the discharge electrode and dust collection electrode, to ensure the long-term stable and efficient operation of the device, the atomizing corona plasma removes the VOCs in the oil smoke exhaust gas and eliminates the odor. In addition, the atomizing corona plasma can purify the circulating water at any time, minimizing the discharge of sewage as possible as it can.

In the process of corona discharge, the air is brokendown instantly to produce plasma, the plasma contains free electrons, high-energy particles and active particles, in which the water mist can further react with the plasma to generate ·OH, ·O and other highly active radicals and, O₃ and other strong oxidizing molecules, ·OH, ·O and other highly active radicals and O₃ and other strong oxidizing molecules can be reacted with VOCs and gas phase molecules with bad odors and smells in the oil smoke exhaust gas to generate non-toxic and harmless small molecules, such as CO₂, H₂O and other non-toxic and harmless small molecules.

In use, the soot particulate matter to be purified (referred to herein as the first oil smoke particulate matter) has a particle size of between 0.01-2 μm, and when the first oil smoke particulate matter in the oil smoke exhaust gas passes through the electrocoagulation component 20, the first oil smoke particulate matter is electrically coagulated and agglomerated to form a second oil smoke particulate matter, and the second oil smoke particulate matter has a particle size larger than the particle size of the first oil smoke particulate matter.

Referring to FIGS. 3A and 3B, the twisted cage corona discharge component 30′ comprises a center shaft 31′, a blade frame 32, and a plurality of discharge electrodes 33, with one end of each of the discharge electrodes 33 being attached to the center shaft 31′ and the other end being attached to the blade frame 32 so as to be integrally formed in a a shape similar to that of a twisted cage. As can be seen from the illustrated cross-section, five discharge electrodes 33 may be provided within each blade frame 32, although of course a greater or lesser number of discharge electrodes 33 may also be provided.

The blade frame 32 is hollow and the discharge electrodes 33 are spaced apart in the hollow region of the blade frame in a spiral shape. That is, overall the discharge electrodes 33 present a spiral shape.

The discharge electrode 33 may be made of materials such as corona spur wire, tungsten wire, molybdenum or stainless steel wire, and the discharge electrode 33 exhibits a corrugated shape with a width of between 5-15 mm.

The discharge electrode 33 is laterally tilted at a predetermined angle with respect to the axis of the center shaft 31′, and the discharge electrode is set at an inclination with respect to the axis of the center shaft 31′, specifically 10-80 degrees (e.g., 30-60 degrees), or 100-170 degrees (e.g., 120-150 degrees).

The center shaft 31′ is driven by a electric motor to achieve rotation, thereby driving the discharge electrode 33 to rotate, and the center shaft 31′ is provided with an energized tube, and a negative high-voltage DC power supply provides power to the discharge electrode 33. The preferred material for the discharge electrodes 33 is corona spur wire, because using corona spur wire as the discharge electrode material results in a low corona voltage and the discharge points are densely distributed throughout the corona spur wire. The corona spur electrode may be made of at least one of pig bristle, nylon wire, steel wire and copper wire; the center shaft 31′ may be made of at least one of iron wire and stainless steel wire, whereby a more inexpensive cost can be realized.

The rotational speed of the discharge electrode 33 or the center shaft 31′ is between 60-300 r/min, and during the high-speed rotation of the discharge electrode 33, the corrugated discharge electrodes and the lateral tilting arrangement cause the gas to be treated to generate a vortex in the central region of the discharge cage (i.e., the space formed by the rotation of the discharge electrode 33). The vertex can improve the charging probability of the soot particulates on the one hand, and on the other hand, it can make the soot particulates with smaller particle sizes adhere to each other to form the soot particulates with larger particle sizes, so that the purification efficiency of the soot particulates can be significantly improved under the above two effects.

Due to the high speed rotation of the discharge twisted cage, the soot particulates are subjected to both electric field force and centrifugal force.

Specifically, the atomizing corona rotating component 30′ provides centrifugal force and electric field force, and when the soot particulates pass through the dynamic twisted cage (horizontal) corona discharge component 30′, since the negative high-voltage DC power supply provides power to the discharge electrodes 33, causing the gas near the discharge electrodes 33 to be ionized to generate a large number of negative charges, and the large-sized soot particulates in the oil smoke exhaust gas are negatively charged under the action of negative DC corona. At the same time, since the discharge electrode 33 in the dynamic twisted cage (horizontal) corona discharge component 30′ is in a high-speed rotation state, centrifugal force can be generated, and the large-size soot particulates in the oil smoke exhaust gas are thrown to the surface of the cylindrical wall of the corona discharge component 30′ under the action of the centrifugal force. The particles are then collected in the oil collection groove and discharged through the oil collection box.

Referring to FIGS. 3C and 3D, a structure integrating atomizing nozzles and a twisted cage dynamic corona discharge component is shown. The structure differs from that shown in FIGS. 3A and 3B in that the plurality of atomizing nozzles 34 are arranged in rows spaced apart along the longitudinal length of the water-through shaft 31 which is provided with the discharge electrodes 33, and that a plurality of rows of the atomizing nozzles 34 are arranged on the entire circumference of the water-through shaft 31.

The plurality of atomizing nozzles 34 are hollow conical nozzles, and the spray area of the plurality of atomizing nozzles 34 is circular.

The atomizing nozzle 34 ejects atomized droplets with a particulate size between 2 and 50 μm.

The spray angle of the atomizing nozzle 34 is at an angle of 25-150° with respect to the centerline of the water-through shaft 31.

The water-through shaft 31 is connected to an external water supply system so that the atomizing nozzle can eject a liquid such as water out.

By providing a plurality of atomizing nozzles 34 along the longitudinal length of the water-through shaft 31, a better atomizing effect can be achieved compared to the structure of FIG. 3A, with each nozzle being able to better spray water onto the corresponding discharge electrode 33. If the atomizing nozzles are provided only at one end of the water-through shaft 31, sufficient droplets will not be obtained at the other end.

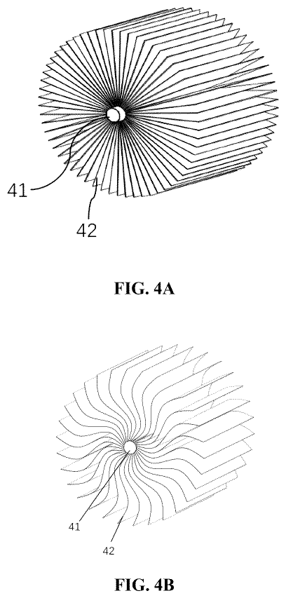

Referring to FIG. 4A, it can be seen that the dynamic adsorption plate 40 comprises a rotating shaft 41 and a plurality of adsorption electrode plates 42 mounted on the rotating shaft 41, the plurality of adsorption electrode plates 42 being spaced apart from each other. Preferably the adsorption electrode plates 42 are spaced apart on the rotating shaft 41 at a circumferential angle of 5-20° in order to allow a better airflow through the plurality of adsorption electrode plates 42. The rotating shaft 41 can be driven to rotate by an external driving device (e.g. a motor) and thereby drive the adsorption electrode plates 42 to rotate with a rotation speed of 500-1500 r/min.

It can be understood that the rotation of the discharge electrode 33 will result in the generation of an vortex in a certain direction, and in order to realize a better treatment effect, it is preferred that the rotation direction of the rotating shaft 41 is set to be opposite thereto, so that a greater airflow disturbance can be realized, and the adsorption electrode plate 42 can contact a greater flow of oil smoke exhaust gas. Of course, it is also possible to set the discharge electrode 33 and the adsorption electrode plate 42 to rotate in the same direction clockwise or counterclockwise, and it is not necessary for them to rotate in the opposite direction, and the person skilled in the art can choose it according to the actual needs.

In embodiments, the adsorption electrode plate 42 is provided with a plurality of fishbone-shaped or corrugated patterns.

The adsorption electrode plates 42 may be provided in a plurality, and each adsorption electrode plate 41 may be an aluminum plate, a galvanized plate, or a steel plate, wherein an aluminum plate is preferred because the aluminum plate is lighter in mass and dissipates heat better, and thus is less likely to catch fire.

The adsorption electrode plate 42 may be provided with a convex and concave structure, such as a herringbone or corrugated pattern to achieve a larger contact area for contacting the oil smoke gas.

The adsorption electrode plates 42 are arranged in a direction perpendicular to the page of FIG. 1 or perpendicular to the direction of flow of the air.

The function of the dynamic adsorption plate 40 is to realize dynamic electrostatic adsorption, when the soot particulates pass through the dynamic adsorption plate 40, due to the positive high-voltage DC power supply providing power to the adsorption electrode plate 42 by the rotating shaft 41 or the corresponding electrically conductive connecting device, the charging soot particulates in the oil smoke exhaust gas are trapped by the dynamic adsorption plate 40 under the action of the electrostatic field, and the soot particulates are thrown to the inner wall of the housing 60 by the action of the rotating adsorption electrode plate 42 and finally gathered in the oil collection box 62 via the oil collection groove 61.

Returning to refer to FIG. 3A, when the center shaft 31′ drives the discharge electrodes 33 to rotate, for example, clockwise or counterclockwise, vortex will be generated in the cavity of the housing 60, and in order to achieve better processing effect, it is preferred that the rotating shaft 41 drives the adsorption electrode plate 42 to rotate in the reverse direction, which can generate the vortex in the other direction, so as to increase the perturbation of the exhaust gas airflow for better electrostatic adsorption.

Referring to FIG. 4B, the dynamic adsorption plate 40 can also be set up to comprise a rotating shaft 41 and a plurality of adsorption electrode plates 42 arranged on the rotating shaft 41 in an S-shaped bending structure. Alternatively, the dynamic adsorption plate 40 comprises a plurality of adsorption electrode plates 42 set up at the other end of the water pass-through shaft 31 in an S-shaped bending structure. That is to say, it is possible to set up the water pass-through shaft 31 and the drive shaft 41 integrally, facilitating better control.

The adsorption electrode plate 42 adopts an S-shaped bending structure, which can increase the adsorption area, and the high-speed rotation can produce a larger vortex, due to the formation of the vortex and the shape is set into an S-shape which can effectively prolong the retention time of the soot particulate matter, which is conducive to improve the adsorption efficiency.

The foregoing is only a preferred embodiment of the present invention, and is not intended to limit the present invention, which may be subject to various changes and variations for those skilled in the art. Any modifications, equivalent substitutions, improvements, etc. made within the spirit and principles of the present invention shall be included in the scope of protection of the present invention.

1. An atomizing corona purification device for oil smoke exhaust gas, characterized in that, the atomizing corona purification device for oil smoke exhaust gas is individually provided with an air inlet and an air outlet at each end of a housing, the housing is provided with therein:
an electrocoagulation component, configured to cause charge coagulation and agglomeration of soot particulates in the oil smoke exhaust gas;
an atomizing corona rotating component, the atomizing corona rotating component comprising a water pass-through shaft, atomizing nozzles disposed at intervals on the water pass-through shaft and a plurality of discharge electrodes arranged in the shape of a twisted cage on a surface of the water pass-through shaft, the plurality of discharge electrodes flinging, by rotating, the soot particulates which is treated by atomizing corona onto an inner wall of the housing; and
a dynamic adsorption plate, the dynamic adsorption plate comprising rotating adsorption electrode plates, the adsorption electrode plates flinging at least a portion of the remaining soot particulates onto the inner wall of the housing.

2. The atomizing corona purification device for oil smoke exhaust gas according to claim 1, characterized in that,
the electrocoagulation component matches or conforms to the shape of the inner wall of the housing.

3. The atomizing corona purification device for oil smoke exhaust gas according to claim 1, characterized in that,
a gap is formed between the electrocoagulation component and the inner wall of the housing and the electrocoagulation component is configured to be able to rotate inside the housing.

4. The atomizing corona purification device for oil smoke exhaust gas according to claim 3, characterized in that the
the electrocoagulation component is integrated at one end of the water-through shaft and is rotated by the water-through shaft.

5. The atomizing corona purification device for oil smoke exhaust gas according to any of claim 1, characterized in that,
the electrocoagulation component comprises an airflow perforation plate and a plurality of discharge flower-shaped conductors in the form of a Bauer ring structure arranged on the airflow perforation plate, wherein the airflow perforation plate is provided with a plurality of airflow perforations, and the airflow perforations are provided with the discharge flower-shaped conductors.

6. The atomizing corona purification device for oil smoke exhaust gas according to claim 5, characterized in that,
the airflow perforations are arranged in a plurality of rows of airflow perforations on the airflow perforation plate and the airflow perforations are spaced apart in each row of airflow perforations;
one discharge flower-shaped conductor is provided at a central region of each airflow perforation, each discharge flower-shaped conductor comprising a plurality of ligulate conductors staggered at intervals along a wall of a space forming the airflow perforation, the plurality of ligulate conductors being connected to each other by conductive wires.
an other region of a central region within the airflow perforation than the plurality of ligulate conductors is formed to allow passage of the oil smoke exhaust gas.

7. The atomizing corona purification device for oil smoke exhaust gas according to claim 6, characterized in that,
the airflow perforation is circular, oval or rectangular, the plurality of the ligulate conductors within each airflow perforation take the form of a circle formed like petals, and ventilation holes therein are circular;
adjacent discharge flower-shaped conductors are connected to a high voltage electrode and a grounding electrode of an AC high voltage power supply respectively.

8. The atomizing corona purification device for oil smoke exhaust gas according to any of claim 1, characterized in that,
on the water-through shaft provided with the discharge electrodes, the plurality of atomizing nozzles are arranged in rows at intervals along a longitudinal length of the water-through shaft, and a plurality of rows of the atomizing nozzles are arranged on an entire circumference of the water-through shaft.

9. The atomizing corona purification device for oil smoke exhaust gas according to claim 8, characterized in that,
the dynamic adsorption plate comprises a rotating shaft and a plurality of adsorption electrode plates arranged on the rotating shaft in an S-shaped bending structure; or
the dynamic adsorption plate comprises a plurality of adsorption electrode plates in an S-shaped bent structure provided at an other end of the water passage shaft.

10. The atomizing corona purification device for oil smoke exhaust gas according to any claim 1, characterized in that the
the housing is cylindrical, the housing is provided with an oil collection groove at the bottom of the housing, the oil collection groove is provided with an oil collection box underneath the oil collection groove, and the oil collection groove and the oil collection box are communicated through an opening in the oil collection groove.

11. The atomizing corona purification device for oil smoke exhaust gas according to claim 8, characterized in that,
the plurality of atomizing nozzles are hollow conical nozzles, and a spraying area of the plurality of atomizing nozzles is circular;
the atomizing nozzle ejects atomized droplets with a particulate size of between 2 and 50 μm;
a spray angle of the atomizing nozzle is at an angle of 25-150° with respect to a centerline of the water-through shaft.

12. A purification method using an atomizing corona purification device for oil smoke exhaust gas according to claim 1, comprising the steps of:
entering the oil exhaust gas to be purified to the housing through the air inlet;
by the electrocoagulation component, making the soot particulates in the oil smoke exhaust gas to be electrically charged and agglomerated;
by rotating the atomizing corona rotating component, inhaling the oil smoke exhaust gas which has been treated by the electrocoagulation component and forming a first vortex rotating counterclockwise or clockwise, wherein the soot particulates particulate in the treated first vortex is flung to the inner wall of the housing after being processed by atomizing corona of the atomizing nozzles and the discharge electrodes;
by rotation of the adsorption electrode plates in the dynamic adsorption plate, forming a second vortex in the opposite direction to the first vortex, while at least a part of the remaining soot particulates is adsorbed by the adsorption electrode plates and flung onto the inner wall of the housing.
